(19) United States
(12) Patent Application Publication
(10) Pub. No.: US 2025/0203164 A1
(43) Pub. Date: Jun. 19, 2025

(54) ARTIFICIAL INTELLIGENCE VIRTUAL ASSISTANT WITH LLM STREAMING

(71) Applicant: Loop Now Technologies, Inc., San Mateo, CA (US)

(72) Inventors: Edwin Chiu, Cupertino, CA (US); Nikhil S. Bapat, Cupertino, CA (US); Shi Feng, East Palo Alto, CA (US); Deric Walintukan, Newark, CA (US); Xiaochen Zhang, Shanghai (CN)

(73) Assignee: Loop Now Technologies, Inc., San Mateo, CA (US)

(21) Appl. No.: 19/062,126

(22) Filed: Feb. 25, 2025

Related U.S. Application Data
(63) Continuation-in-part of application No. 18/989,061, filed on Dec. 20, 2024.
Application No. 18/989,061 is a continuation-in-part of application No. 18/820,456, filed on Aug. 30, 2024.
Application No. 18/820,456 is a continuation-in-part of application No. 18/585,212, filed on Feb. 23, 2024.
(60) Provisional application No. 63/649,966, filed on May 21, 2024.
(60) Provisional application No. 63/638,476, filed on Apr. 25, 2024.
(60) Provisional application No. 63/571,732, filed on Mar. 29, 2024.
(60) Provisional application No. 63/557,622, filed on Feb. 26, 2024.
(60) Provisional application No. 63/557,623, filed on Feb. 26, 2024.
(60) Provisional application No. 63/557,628, filed on Feb. 26, 2024.
(60) Provisional application No. 63/613,312, filed on Dec. 21, 2023.
(60) Provisional application No. 63/604,261, filed on Nov. 30, 2023.
(60) Provisional application No. 63/546,768, filed on Nov. 1, 2023.
(60) Provisional application No. 63/546,077, filed on Oct. 27, 2023.
(60) Provisional application No. 63/536,245, filed on Sep. 1, 2023.
(60) Provisional application No. 63/524,900, filed on Jul. 4, 2023.
(60) Provisional application No. 63/522,205, filed on Jun. 21, 2023.
(60) Provisional application No. 63/472,552, filed on Jun. 12, 2023.
(60) Provisional application No. 63/464,207, filed on May 5, 2023.
(60) Provisional application No. 63/458,733, filed on Apr. 12, 2023.
(60) Provisional application No. 63/458,458, filed on Apr. 11, 2023.
(60) Provisional application No. 63/458,178, filed on Apr. 10, 2023.
(60) Provisional application No. 63/454,976, filed on Mar. 28, 2023.
(60) Provisional application No. 63/447,918, filed on Feb. 24, 2023.
(60) Provisional application No. 63/447,925, filed on Feb. 24, 2023.

(51) Int. Cl. H04N 21/472; G06T 13/40; G10L 13/08; G10L 15/22

(52) U.S. Cl. CPC H04N 21/472; G06T 13/40; G10L 13/08; G10L 15/22

(57) ABSTRACT

Techniques for video streaming are disclosed. Audio input related to products for sale is received from a user within an embedded interface. The embedded interface includes an artificial intelligence virtual assistant represented by a synthetic human host. The audio input is captured by a natural language processing engine, creating a data segment which is sent to a large language model (LLM). The data segment can be divided into one or more subsegments. Each subsegment can be processed independently by the LLM to generate a response based on product information stored in the LLM database. The LLM responses are converted by a text-to-speech (TTS) converter into an audio response. The audio responses are used to produce a video segment including the synthetic host performing the audio stream. The capturing and processing of user audio continues to allow a human-like dialogue with the synthetic human host.

### RELATED APPLICATIONS

This application claims the benefit of U.S. provisional patent applications “Artificial Intelligence Virtual Assistant With LLM Streaming” Ser. No. 63/557,622, filed Feb. 26, 2024, “Self-Improving Interactions With An Artificial Intelligence Virtual Assistant” Ser. No. 63/557,623, filed Feb. 26, 2024, “Streaming A Segmented Artificial Intelligence Virtual Assistant With Probabilistic Buffering” Ser. No. 63/557,628, filed Feb. 26, 2024, “Artificial Intelligence Virtual Assistant Using Staged Large Language Models” Ser. No. 63/571,732, filed Mar. 29, 2024, “Artificial Intelligence Virtual Assistant In A Physical Store” Ser. No. 63/638,476, filed Apr. 25, 2024, and “Ecommerce Product Management Using Instant Messaging” Ser. No. 63/649,966, filed May 21, 2024.

This application is a continuation-in-part of U.S. patent application “Artificial Intelligence Virtual Assistant Using Large Language Model Processing” Ser. No. 18/989,061, filed Dec. 20, 2024, which claims the benefit of U.S. provisional patent applications “Artificial Intelligence Virtual Assistant Using Large Language Model Processing” Ser. No. 63/613,312, filed Dec. 21, 2023, “Artificial Intelligence Virtual Assistant With LLM Streaming” Ser. No. 63/557,622, filed Feb. 26, 2024, “Self-Improving Interactions With An Artificial Intelligence Virtual Assistant” Ser. No. 63/557,623, filed Feb. 26, 2024, “Streaming A Segmented Artificial Intelligence Virtual Assistant With Probabilistic Buffering” Ser. No. 63/557,628, filed Feb. 26, 2024, “Artificial Intelligence Virtual Assistant Using Staged Large Language Models” Ser. No. 63/571,732, filed Mar. 29, 2024, “Artificial Intelligence Virtual Assistant In A Physical Store” Ser. No. 63/638,476, filed Apr. 25, 2024, and “Ecommerce Product Management Using Instant Messaging” Ser. No. 63/649,966, filed May 21, 2024.

The U.S. patent application “Artificial Intelligence Virtual Assistant Using Large Language Model Processing” Ser. No. 18/989,061, filed Dec. 20, 2024 is also a continuation-in-part of U.S. patent application “Livestream With Large Language Model Assist” Ser. No. 18/820,456, filed Aug. 30, 2024, which claims the benefit of U.S. provisional patent applications “Livestream With Large Language Model Assist” Ser. No. 63/536,245, filed Sep. 1, 2023, “Non-Invasive Collaborative Browsing” Ser. No. 63/546,077, filed Oct. 27, 2023, “AI-Driven Suggestions For Interactions With A User” Ser. No. 63/546,768, filed Nov. 1, 2023, “Customized Video Playlist With Machine Learning” Ser. No. 63/604,261, filed Nov. 30, 2023, “Artificial Intelligence Virtual Assistant Using Large Language Model Processing” Ser. No. 63/613,312, filed Dec. 21, 2023, “Artificial Intelligence Virtual Assistant With LLM Streaming” Ser. No. 63/557,622, filed Feb. 26, 2024, “Self-Improving Interactions With An Artificial Intelligence Virtual Assistant” Ser. No. 63/557,623, filed Feb. 26, 2024, “Streaming A Segmented Artificial Intelligence Virtual Assistant With Probabilistic Buffering” Ser. No. 63/557,628, filed Feb. 26, 2024, “Artificial Intelligence Virtual Assistant Using Staged Large Language Models” Ser. No. 63/571,732, filed Mar. 29, 2024, “Artificial Intelligence Virtual Assistant In A Physical Store” Ser. No. 63/638,476, filed Apr. 25, 2024, and “Ecommerce Product Management Using Instant Messaging” Ser. No. 63/649,966, filed May 21, 2024.

The U.S. patent application “Livestream With Large Language Model Assist” Ser. No. 18/820,456, filed Aug. 30, 2024 is also a continuation-in-part of U.S. patent application “Synthesized Realistic Metahuman Short-Form Video” Ser. No. 18/585,212, filed Feb. 23, 2024, which claims the benefit of U.S. provisional patent applications “Synthesized Realistic Metahuman Short-Form Video” Ser. No. 63/447,925, filed Feb. 24, 2023, “Dynamic Synthetic Video Chat Agent Replacement” Ser. No. 63/447,918, filed Feb. 24, 2023, “Synthesized Responses To Predictive Livestream Questions” Ser. No. 63/454,976, filed Mar. 28, 2023, “Scaling Ecommerce With Short-Form Video” Ser. No. 63/458,178, filed Apr. 10, 2023, “Iterative AI Prompt Optimization For Video Generation” Ser. No. 63/458,458, filed Apr. 11, 2023, “Dynamic Short-Form Video Transversal With Machine Learning In An Ecommerce Environment” Ser. No. 63/458,733, filed Apr. 12, 2023, “Immediate Livestreams In A Short-Form Video Ecommerce Environment” Ser. No. 63/464,207, filed May 5, 2023, “Video Chat Initiation Based On Machine Learning” Ser. No. 63/472,552, filed Jun. 12, 2023, “Expandable Video Loop With Replacement Audio” Ser. No. 63/522,205, filed Jun. 21, 2023, “Text-Driven Video Editing With Machine Learning” Ser. No. 63/524,900, filed Jul. 4, 2023, “Livestream With Large Language Model Assist” Ser. No. 63/536,245, filed Sep. 1, 2023, “Non-Invasive Collaborative Browsing” Ser. No. 63/546,077, filed Oct. 27, 2023, “AI-Driven Suggestions For Interactions With A User” Ser. No. 63/546,768, filed Nov. 1, 2023, “Customized Video Playlist With Machine Learning” Ser. No. 63/604,261, filed Nov. 30, 2023, and “Artificial Intelligence Virtual Assistant Using Large Language Model Processing” Ser. No. 63/613,312, filed Dec. 21, 2023.

Each of the foregoing applications is hereby incorporated by reference in its entirety.

### FIELD OF ART

This application relates generally to video streaming and more particularly to an artificial intelligence virtual assistant with LLM streaming.

### BACKGROUND

The history of selling products and services can be traced back to ancient times. In many civilizations across the world, traders would barter goods and services with one another. Trade routes over land and sea allowed caravans and shipping fleets to carry products to nations and peoples all over the world. However, much of the modern sales industry we know today began in the United States. The development of modern sales management required a stable currency, the rule of law, the protection of private property, and the availability of credit. All of these ingredients became aspects of the American economic system. The emergence of salesmanship in the U.S. was also related to the scale of American firms that were founded in the late nineteenth and early twentieth centuries. Huge manufacturing corporations hired salespeople in the hundreds and even thousands to create demand for their products, including cars, steel, rail transportation, oil, and shipping.

Salesmanship boomed in America for cultural reasons as well. The U.S. held routine, scheduled, democratic elections and had no established state church or hereditary aristocracy. Salesmanship provided political and religious groups with a way to compete against their rivals for followers without fear of government reprisals or censure. With more fluid class boundaries than in European countries, the skills of salesmanship offered a pathway to personal success. By the early twentieth century, Americans read how-to-sell books in large enough numbers to turn several of them into best-sellers.

From the 1920s through the 1950s, sales methodology took a number of twists and turns including psychological selling, relationship selling, and barrier selling. Psychological selling is focused on understanding the emotions, motivations, and behaviors that drive people to make purchasing choices. Relationship selling is a sales technique which prioritizes building a connection with customers and potential buyers to close sales. By establishing a personal relationship with the customer, the salesperson can help foster loyalty toward a product or service, which helps retain long-term customers and gain new ones because they feel valued by the company. Barrier selling used a series of leading questions asked by the salesperson that could only be answered with “yes.” This technique was used to guide customers into agreeing with the sales representative and making a purchase. The 1960s saw the rise of consultative selling, which focused on understanding the customer's needs and providing solutions to their problems. In the 1980s, solution selling emerged, which emphasized the importance of selling a complete solution to the customer's problem rather than just a product. Today, sales methodologies continue to evolve, with an increasing emphasis on data-driven sales.

Salesmanship has changed and evolved significantly since its beginnings. From the early days of traveling vendors and merchants to today's modem salesforces, selling products has been an essential part of the American economy and culture. Sales skills offer a path of personal success, and books, videos, and seminars on salesmanship skills continue to sell well today. The changes in salesmanship techniques and approaches have evolved as the culture, economy, and technology embedded in the country have changed. Doubtless, salesmanship will continue to adapt as our culture is influenced and altered by continued changes brought to us from all over the world.

### SUMMARY

Successful sales and customer service interactions require product knowledge, dedicated support systems, competitive pricing, and excellent communication skills. Whether in person or through digital methods, the representative of the company must know the product, know how to support it, and be able to communicate effectively with the customer. The connection between salesperson and customer must form quickly and engage the potential buyer in a way that encourages them to purchase and ideally return for additional products or services. Forming good rapport with a customer is both art and science. Listening to the customer to understand the information they need, addressing concerns, and presenting the answers in an effective manner takes practice, even for professional sales and customer service staff members. The more quickly and reliably the correct information the customer requires can be accessed and delivered, the better. As the global market expands potential sales many times, strong sales and support outlets must grow to meet the need.

Techniques for video streaming are disclosed. Audio input related to products for sale is received from a user within an embedded interface. The embedded interface includes an artificial intelligence virtual assistant represented by a synthetic human host. The audio input is captured by a natural language processing engine, creating a data segment which is sent to a large language model (LLM). The data segment can be divided into one or more subsegments. Each subsegment can be processed independently by the LLM to generate a response based on product information stored in the LLM database. The LLM responses are converted by a text-to-speech (TTS) converter into an audio response. The audio responses are used to produce a video segment including the synthetic host performing the audio stream. The capturing and processing of user audio continue to allow a human-like dialogue with the synthetic human host.

A computer-implemented method for video streaming is disclosed comprising: receiving audio input from a user, wherein the receiving occurs within an embedded interface, wherein the embedded interface includes an artificial intelligence virtual assistant, wherein the artificial intelligence virtual assistant comprises a synthetic human host, wherein the audio input from the user relates to one or more products for sale, and wherein the audio input comprises an interaction; capturing, by a natural language processing (NLP) engine, the audio input, wherein the capturing produces a data segment, and wherein the data segment is sent to a large language model (LLM); processing, by the LLM, the data segment that was sent, wherein the processing generates a final response to the data segment; converting, by a text-to-speech converter, the final response to a final audio response; producing a final video segment, wherein the final video segment is based on the final audio response, wherein the producing includes animating the artificial intelligence virtual assistant, wherein the animating is based on the final audio response; and streaming, within the embedded interface, a short-form video, wherein the short-form video includes the final video segment that was produced. Some embodiments comprise evaluating the data segment, wherein the evaluating includes separating the data segment into a plurality of data subsegments. In embodiments, the processing includes a first data subsegment within the plurality of data subsegments, wherein the processing generates a first response to the first data subsegment, wherein the first response is included in the final response. In embodiments, the converting includes the first response. Some embodiments comprise buffering a second data subsegment within the plurality of data subsegments. In embodiments, the processing includes the second data subsegment, wherein the processing generates a second response to the second data subsegment, wherein the second response is included in the final response.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for an artificial intelligence virtual assistant with LLM streaming.

FIG. 2 is a flow diagram for processing data segments.

FIG. 3 is an infographic for an artificial intelligence virtual assistant with LLM streaming.

FIG. 4 is an example of an interaction with an artificial intelligence virtual assistant.

FIG. 5 is an example of an artificial intelligence virtual assistant showing a short-form video.

FIG. 6 is a first diagram for LLM streaming.

FIG. 7 is a second diagram for LLM streaming.

FIG. 8 is an example of an ecommerce purchase.

FIG. 9 is a system diagram for an artificial intelligence virtual assistant with LLM streaming.

### DETAILED DESCRIPTION

Online websites and applications that highlight products and services for sale are immensely popular and can engage hundreds if not thousands of users. Along with the technical challenges involved in supporting and maintaining network connections with customers, the challenge of responding to viewer questions and comments quickly and accurately can be equally difficult. Accessing the right information quickly and sending it back to the user who is looking for it can be the difference between a sale or a potential customer leaving the website. Understanding the subtleties of user questions can be a challenge as well. Large language models (LLM) including natural language processing (NLP) can help by monitoring the user interactions and generating answers to questions as they arise. As the volume of digital communication increases for sales and customer support, the uses of LLM can help encourage rapid and accurate viewer engagement, increased sales, and long-term customer/vendor relationships.

Techniques for video streaming are disclosed. Users interact with a website or application that includes an embedded interface. The embedded interface includes an artificial intelligence (AI) virtual assistant. The AI virtual assistant is represented as a synthetic human host which is selected to engage the user and deliver the information needed to complete a sales or service transaction. The embedded interface captures audio input from the user with a natural language processing (NLP) engine and transforms the user input into a text data segment that becomes input for a large language model (LLM). The data segment includes any speaking errors, pauses, verbal ticks, and so on, along with the question or comment made by the user. This additional data allows the LLM to improve its ability to generate responses that are human-like in quality. The LLM processes the data segment and generates a response to the question or comments made by the user. The LLM accesses articles, short-form videos, social media influencers, product experts, and other sources to generate responses that both answer the user and encourage continued dialogue. The response generated by the LLM is converted from text into an audio stream employing a text-to-speech (TTS) converter using the voice of the synthetic human host. The response includes speech errors, pauses, and so on to give the voice a more lifelike sound and feel. Once the response has been converted to audio, it is forwarded to a video production process that includes a game engine in order to generate a video clip of the synthetic human host performing the audio response. The game engine allows the synthetic human host to move in a lifelike manner, holding up or demonstrating products, directing the user's attention to embedded short-form videos, showing clothing or accessories, and so on. As the synthetic human host video is generated, it is streamed to the user through the embedded interface.

Audio input from the user is collected and forwarded to the LLM continuously. Memory buffers that feed the LLM allow user input to be stored and forwarded to the LLM in a constant stream so that responses are generated and converted into video as quickly as possible. In some cases, multiple LLM instances or various LLM versions can be used to allow for more rapid response generation that quickly and accurately addresses the user requests. The buffers can feed multiple LLM instances and versions as soon as the LLM is ready to receive the input, allowing the dialogue between the user and the synthetic human host to have the rhythm and pace of a human conversation. This allows the host/user interaction to be engaging and encouraging to the user, leading to higher sales opportunities and greater customer satisfaction.

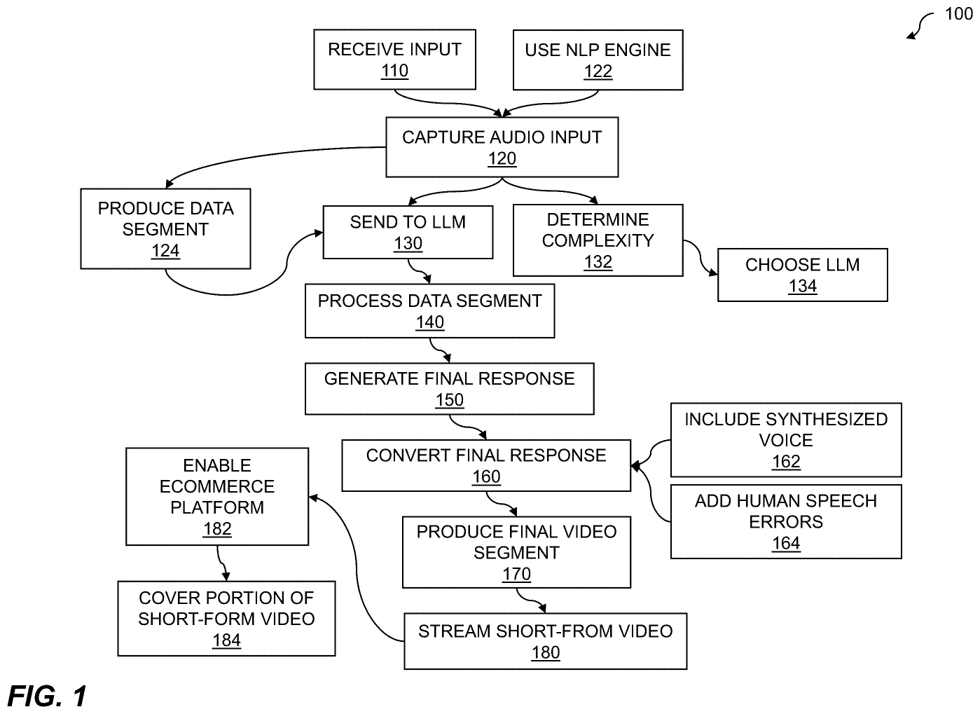

FIG. 1 is a flow diagram for an artificial intelligence virtual assistant with LLM streaming. The flow 100 includes receiving audio input 110 from a user, wherein the receiving occurs within an embedded interface, wherein the embedded interface includes an artificial intelligence virtual assistant, wherein the artificial intelligence virtual assistant comprises a synthetic human host, wherein the audio input from the user relates to one or more products for sale, and wherein the audio input comprises an interaction. In embodiments, the audio input is included in a video chat. The user can speak to a video chat window; into a mobile phone, pad, or tablet; and so on. In some embodiments, the user input comprises text. The user can respond to the synthetic human by typing a question or comment into a chat text box. The text box can be generated by a website or the embedded interface window.

In embodiments, the embedded interface can comprise a website. The website can be an ecommerce site for a single vendor or brand, a group of businesses, a social media platform, and so on. The website can be displayed on a portable device. The portable device can be an Over-the-Top (OTT) device such as a mobile phone, laptop computer, tablet, or pad. The accessing of the website can be accomplished using a browser running on the device. In embodiments, the embedded interface comprises an app running on a mobile device. The app can use HTTP, TCP/IP, or DNS to communicate with the Internet, web servers, cloud-based platforms, and so on.

In embodiments, the artificial intelligence (AI) virtual assistant can be based on the user information collected by the embedded interface. An image of a live human can be captured from media sources including one or more photographs, videos, livestream events, and livestream replays, including the voice of the livestream host. A human host can be recorded with one or more cameras, including videos and still images, and microphones for voice recording. The recordings can include one or more angles of the human host and can be combined to comprise a dynamic 360-degree photorealistic representation of the human host. The voice of a human host can be recorded and included in the synthetic human host. The images of the live human can be isolated and combined in an AI machine learning model into a 3D model that can be used to generate a video segment in which the synthetic human responds to the user request using answers generated by a large language model (LLM). In some embodiments, a game engine can be used to generate a series of animated movements, including basic actions such as sitting, standing, holding a product, presenting a video or photograph, describing an event, and so on. Specialized movements can be programmed and added to the animation as needed. Dialogue can be added so that the face of the presenter moves appropriately as the words are spoken. The result can be a performance by the synthetic human, combining animation generated by a game engine and the 3D model of the individual, including the voice of the individual. Other embodiments include animating the lips of the synthetic human. The animation can be accomplished by sampling a video or pictures of an avatar. The sampling can result in a database of video frames of the avatar. The frames in the database can be categorized by sounds or phonemes. The audio input from the user can be analyzed, for example, with a Mel spectrogram, and sounds or phonemes from the audio input can be matched to the appropriate frame in the database.

In embodiments, the user can request an interaction by clicking on an icon or button displayed in the embedded interface or a help button on a webpage, asking for help in a text chat box, navigating to a help desk screen, pressing a phone button during a call, submitting an email to a help desk address, and so on. The user can initiate an interaction from the main webpage of a website, a help menu page, a webpage presenting a specific product, a text or video chatbot embedded in the website, and so on.

The flow 100 includes capturing 120, by a natural language processing (NLP) engine 122, the audio input, wherein the capturing produces a data segment 124, and wherein the data segment is sent to a large language model (LLM) 130. In embodiments, the audio input generated by the user is converted into text, including any user errors, incorrect words, grammar inconsistencies, and so on. The conversion can be done using an online conversion application, AI transcription service, automatic speech recognition (ASR) application, and so on. In some embodiments, the natural language processing (NLP) engine 122 converts the audio input to text. NLP is a category of artificial intelligence (AI) concerned with interactions between humans and computers using natural human language. NLP can be used to develop algorithms and models that allow computers to understand, interpret, generate, and manipulate human language. In embodiments, the large language model (LLM) 130 uses NLP to understand the text and the context of voice and text communication during the interaction. A large language model is a type of machine learning model that can perform a variety of natural language tasks, including generating and classifying text, answering questions in a human conversational manner, and translating text from one language to another. The LLM database can include audio and text interactions between users and the synthetic human host. NLP can be used to detect one or more topics discussed by the user and synthetic human. Evaluating a context of the interaction can include determining a topic of discussion; understanding references to and information from other websites; demonstrating products for sale or product brands; and recognizing livestream hosts associated with a brand, product for sale, or topic. In embodiments, the text of the user input becomes a segment of data 124 that is sent to the LLM for analysis.

The flow 100 includes determining 132 a complexity of the audio input. In embodiments, the determining includes choosing 134 an LLM, from one or more LLMs, wherein the choosing is based on the complexity of the audio input. There are many LLMs that have been created by artificial intelligence labs, corporate entities, private companies, and so on. Different LLMs focus on various aspects of language processing and production. For example, some LLMs are designed to imitate the structure and function of a human brain, so that language input and responses closely resemble human speech. Others process data segments in parallel, allowing them to predict and process text more quickly. Some work better with specific languages, including English, Mandarin, French, German, Russian, and so on. Some LLMs are designed specifically for particular industries or areas of study. One particular LLM was designed for scientists and was trained on collections of academic material. In embodiments, the text data generated by the user can be analyzed and used to determine which LLM can be most effective in generating responses that meet the requirements of the user and the host system. These various LLMs can require different levels of compute resources to generate responses. In embodiments, the determining 132 can conclude that a “lighter” (less compute intensive) LLM can be sufficient for generating a response. In other embodiments, the determining 132 can conclude that a “heavier” (more compute intensive) LLM is needed to generate a sufficient answer. In still other embodiments, the determining causes the audio input to be sent to multiple LLM models for additional checking, to generate partial responses, and so on. When multiple partial responses are generated, they can be assembled together later to form a final response. The determining 132 can thus provide flexibility to select an appropriate LLM model based on the complexity of the audio input, save compute resources, speed the process of generating an answer back to the user, generate a complex answer by engaging multiple LLMs, and so on.

The flow 100 includes processing 140, by the LLM, the data segment that was sent, wherein the processing generates 150 a final response to the data segment. In embodiments, the one or more LLMs used to process the data segment are trained with voice and text interactions between users, human sales associates, help desk staff members, product experts, and AI virtual assistants. Information articles and questions covering products and services offered for sale by the website can be included in the LLM database. The information on products can be analyzed by the LLM and used to generate answers to questions and comments related to products and services offered for sale. In some embodiments, answers generated by the LLM are scored based on their correctness. A correct answer must address the question actually asked by the user and must provide the appropriate information based on the information article related to the product or service involved. The response generated by the LLM can be in text. In embodiments, the LLM can start a self-learning process when an answer is not available or under a score threshold. The self-learning process can include crawling web sites or generating instructions to update a database of product information. The updating can be accomplished by a client management system (CMS).

The flow 100 includes converting 160, by a text-to-speech converter, the final response to a final audio response. Text-to-speech (TTS) applications can break down text into small units of sound called phonemes, and then use a database of recorded voices to speak each phoneme. In embodiments, the text-to-speech converter includes 162 a synthesized voice. The synthesized voice can be based on a voiceprint from a human. The synthesized voice can include AI-generated speech. The synthesized voice 162 is used to perform the text response, to the user, created by the LLM. Artificial intelligence and deep learning algorithms can be used to continually update and refine the voice performances so that they are more natural and human-like.

The converting 160 can include adding one or more simulations of human speech errors 164 to the final audio response. The final audio response can include pauses to simulate human cognitive processing rates. Humans do not speak perfectly with each other. Their speech includes filler words such as “um,” “ah,” “uh,” and so on. These pauses are often used to give the speaker time to assemble their thoughts or correctly phrase a sentence. Humans also make errors when they speak. They use the wrong words, get words in the wrong order, mispronounce, slur, speak too quickly or too slowly, mumble, and so on. They make grammar mistakes, such as confusing “may” and “might,” placing adjectives in the wrong order, using “me” and “my” incorrectly, and so on. In embodiments, the LLM adds simulations of speech errors and pauses into the user response audio stream in order to match human speech more closely. In this case, filler words can be added, words can be duplicated at the beginning of phrases, the pace of speech can slow down or speed up slightly during the audio stream, and so on. In embodiments, the number of pauses and errors added to the audio stream is regulated in order to make sure that the primary content of the response is preserved and communicated to the user.

The flow 100 includes producing 170 a final video segment, wherein the final video segment is based on the final audio response, wherein the producing includes animating the artificial intelligence virtual assistant, wherein the animating is based on the final audio response. In embodiments, the final audio response can be forwarded to one or more processors that have a copy of a 3D image of the synthetic human host and have access to a game engine. The image of the synthetic human host can be combined with the synthesized voice and used to generate a video clip of the synthetic human performing the audio segment. In embodiments, the synthesizing is based on phoneme mapping, wherein the phoneme mapping determines a mouth and lip position of the synthetic human. A phoneme is a discrete sound that is associated with a letter of the alphabet. Some letters have more than one associated phoneme. Phonemes can also be associated with letter combinations, such as “th,” “qu,” “ing,” and so on. In embodiments, each audio segment can be broken down into phonemes. Phonemes can be mapped to corresponding face, mouth, lip, and eye movements so that as a word is spoken by the synthetic human, the movement of the mouth, lip, face, and eyes correspond. Thus, the synthetic human is speaking the words contained in the audio segment as naturally as a real human does. Speech errors and pauses added by the LLM are included in the video clip. For example, when the synthetic human pauses to “think” in the midst of a sentence, the eyes can look down and to the right or up at the ceiling, along with slight tilts of the head, to simulate the process of thinking.

The flow 100 includes streaming 180, within the embedded interface, a short-form video, wherein the short-form video includes the final video segment that was produced. As video segments are generated, they can be presented immediately to the user. The embedded interface displays the assembled video segment performed by the synthetic human host in a webpage window, video chat window, etc. In embodiments, as the user views the video segment and produces additional questions or comments, the capturing of user comments, LLM processing, TTS converting, video producing, and streaming can be repeated. The user can continue to interact with the synthetic human host, generating additional input collected by the embedded interface. The collecting of user input, creating a response, producing audio segments and related video clips, and streaming to the user continues so that the interaction between the user and the synthetic human appears as natural as two humans interacting within a video chat.

The streaming 180 includes enabling 182 an ecommerce purchase of the one or more products for sale. In embodiments, the ecommerce purchase includes a representation of the one or more products for sale in an on-screen product card. The enabling the ecommerce purchase can include a virtual purchase cart. The virtual purchase cart can cover 184 a portion of the short-form video that was streamed. The synthetic human host can demonstrate, endorse, recommend, and otherwise interact with one or more products for sale. An ecommerce purchase of at least one product for sale can be enabled to the user, wherein the ecommerce purchase is accomplished within the embedded interface. As the host interacts with and presents the products for sale, a product card representing one or more products for sale can be included within a video shopping window. An ecommerce environment associated with the video can be generated on the viewer's mobile device or other connected television device as the rendering of the video progresses. The ecommerce environment on the viewer's mobile device can display a livestream or other video event and the ecommerce environment at the same time. A mobile device user can interact with the product card in order to learn more about the product with which the product card is associated. While the user is interacting with the product card, the short-form video continues to play. Purchase details of the at least one product for sale can be revealed, wherein the revealing is rendered to the viewer. The viewer can purchase the product through the ecommerce environment, including a virtual purchase cart. The viewer can purchase the product without having to “leave” the short-form video. Leaving the video can include having to disconnect from the event, open an ecommerce window separate from the short-form video, and so on. The video can continue to play while the viewer is engaged with the ecommerce purchase. In embodiments, the short-form video can continue “behind” the ecommerce purchase window, where the virtual purchase window can obscure or partially obscure the video window.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors. Various embodiments of the flow 100, or portions thereof, can be included on a semiconductor chip and implemented in special purpose logic, programmable logic, and so on.

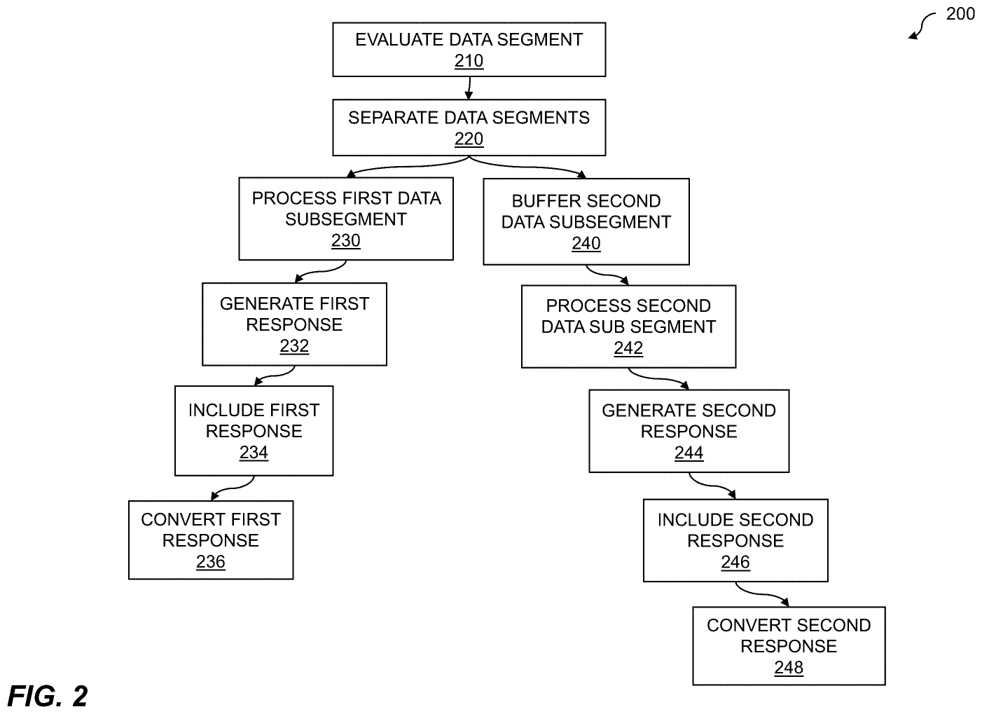

FIG. 2 is a flow diagram for processing data segments. The flow 200 includes evaluating 210 a data segment, wherein the evaluating includes separating 220 the data segment into a plurality of data subsegments. In embodiments, a user generates a series of questions and comments as part of an initial interaction with the AI virtual assistant. For example, the user shopping for kitchen cabinets might ask about wood types, stains, paints, door options, and so on as part of a first inquiry on a website. In embodiments, the speech generated by the user can be captured by the embedded interface as an audio data segment. The audio data segment can be evaluated by a natural language processing (NLP) engine included in the large language model (LLM), wherein the segmenting results in a plurality of audio subsegments. In embodiments, the segmenting conforms to a natural auditory cadence. Natural auditory cadence refers to the rhythmic pattern of sound and movement in human activities, such as speech, music, or sports. It is the natural synchronization of sound and movement that gives a sense of harmony and flow. For example, variations in volume, speed, and diction as a person speaks can give the listener a sense of the speaker's emotion and attitude. The audio stream generated by the user can be broken into smaller subsegments based on the auditory cadence of the entire stream. Each sentence can be broken down into smaller sections based on phrasing, word emphasis, the position of a word in the sentence, and so on. For example, the user's questions about wood types, paint, stain, door options, and so on can be separated so that the first data subsegment contains the user question about cabinet wood types, the second subsegment contains the user question about wood stains, and so on. The order of the data subsegments can be recorded so that processing by the LLM can occur out of order. The responses can be put back in order before or at the time that they are rendered into video and displayed to the user.

The flow 200 includes processing a first data subsegment 230. Recall that a data segment can be sent to an LLM 130 for processing 140. In embodiments, the processing includes a first data subsegment within the plurality of data subsegments, wherein the processing generates a first response 232 to the first data subsegment, wherein the first response is included in the final response 234. In embodiments, information on products presented on a website can be analyzed by a machine learning model and used to generate answers to questions and comments related to products and services offered for sale. Datasets of questions and answers can be arranged using various data schemes, including the Stanford Question Answering Dataset (SQuAD), WikiQA, SelQA, InfoQA, and so on. These datasets can be used to train machine learning models to analyze questions regarding products, services, and other subjects and to generate suitable answers based on information articles supplied on those subjects. In embodiments, answers generated by the LLM are scored based on their correctness. A correct answer must address the question actually asked by the user and must provide the appropriate information based on the information article related to the product or service involved. For example, a user question about kitchen cabinet wood types can generate a response that includes information about maple, cherry, white oak, pine, and so on, depending on the wood types made available by the website or mobile application using the embedded interface. Information about pricing, delivery times, sizes, and so on can be included in the response, based on information available on the website.

The flow 200 includes converting, by a text-to-speech converter, the final response to a final audio response. The converting includes 236 the first response. In embodiments, the first response generated by the LLM can be converted into an audio response. The audio response performance can use the voice of the synthesized human host selected to interact with the user. The synthesized voice can be based on a voiceprint from a human. The synthesized voice can be based on AI-generated speech, wherein the AI-generated speech includes the response that was created. The converting can include adding one or more simulations of human speech errors, such as repeated words, words in the wrong order, grammar mistakes, and so on. The converting can include adding pauses to the audio stream to simulate human cognitive processing rates, including filler words such as “um,” “ah,” “uh,” and so on. The LLM adds simulations of speech errors and pauses into the user response audio stream in order to match human speech more closely. Filler words are added, words are duplicated at the beginning of phrases, the pace of speech slows down or speeds up slightly during the audio stream, and so on. In embodiments, the number of pauses and errors added to the audio stream is regulated in order to make sure that the primary content of the response is preserved and communicated to the user.

The flow 200 includes buffering a second data subsegment 240 within the plurality of data subsegments. Buffering is the process of preloading and storing data in a reserved area of memory called a buffer. In embodiments, the processing includes 242 the second data subsegment, wherein the processing generates 244 a second response to the second data subsegment, wherein the second response is included 246 in the final response. In embodiments, the converting includes 248 the second response. In embodiments, as the first data subsegment is processed by the LLM, additional data subsegments, including a second, third, fourth, and so on segments, can be stored in one or more memory buffers that can be accessed by the LLM. As each subsegment is analyzed by the LLM and a response is generated, the next subsegment can be queued up and waiting in a memory buffer to be analyzed. As soon as the first subsegment response is completed, the next subsegment can be processed. In some embodiments, the input subsystem of the LLM reads in the second data subsegment for analysis as the output subsystem of the LLM is writing out the response to the first data subsegment. In some embodiments, additional instances of the LLM run in parallel, so that the buffer can feed data subsegments to multiple LLM instances at the same time. In some embodiments, different LLMs are selected based on the complexity of the question or comment generated by the user. As each LLM response is generated, the subsegment responses can be converted into audio streams and forwarded to video processing. The result is that responses to the user requests and comments can be generated more quickly and presented in a more timely manner.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors. Various embodiments of the flow 200, or portions thereof, can be included on a semiconductor chip and implemented in special purpose logic, programmable logic, and so on.

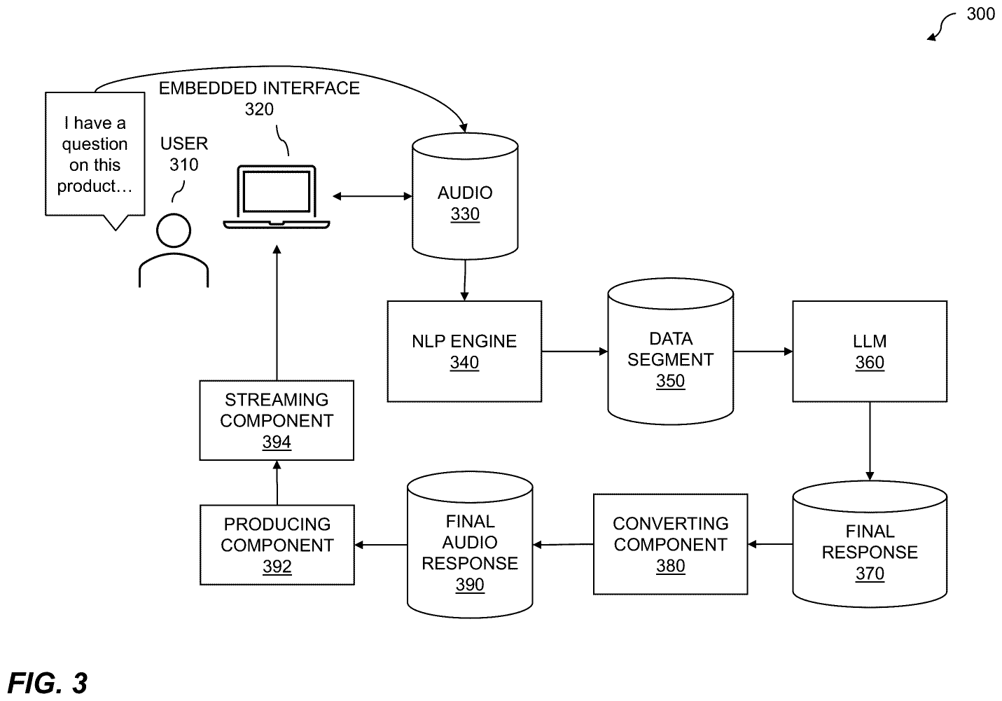

FIG. 3 is an infographic for an artificial intelligence virtual assistant with LLM streaming. The infographic 300 includes receiving audio input 330 from a user 310, wherein the receiving occurs within an embedded interface 320, wherein the embedded interface includes an artificial intelligence virtual assistant, wherein the artificial intelligence virtual assistant comprises a synthetic human host, wherein the audio input from the user relates to one or more products for sale, and wherein the audio input comprises an interaction. In embodiments, the audio input is included in a video chat. The user can speak to a video chat window; into a mobile phone, pad, or tablet; and so on. In some embodiments, the user input comprises text. The user can respond to the synthetic human by typing a question or comment into a chat text box. The text box can be generated by a website or the embedded interface window.

In embodiments, the embedded interface can comprise a website. The website can be an ecommerce site for a single vendor or brand, a group of businesses, a social media platform, and so on. The website can be displayed on a portable device. The accessing of the website can be accomplished using a browser running on the device. In embodiments, the embedded interface comprises an app running on a mobile device. The app can use HTTP, TCP/IP, or DNS to communicate with the Internet, web servers, cloud-based platforms, and so on.

The infographic 300 includes capturing, by a natural language processing (NLP) engine 340, the audio input 330, wherein the capturing produces a data segment 350, and wherein the data segment is sent to a large language model (LLM) 360. In embodiments, the audio input 330 generated by the user 310 is converted into text, including any user errors, incorrect words, grammar inconsistencies, and so on. The conversion can be accomplished using an online conversion application, AI transcription service, automatic speech recognition (ASR) application, and so on. In some embodiments, the natural language processing (NLP) engine 340 converts the audio input to text. The large language model (LLM) 360 uses NLP to understand the text and the context of voice and text communication during the interaction. The LLM database can include audio and text interactions between users and the synthetic human host. NLP can detect one or more topics discussed by the user and synthetic human, including products and services for sale by a website or application. Evaluating a context of the interaction can include determining a topic of discussion; understanding references to and information from other websites; demonstrating products for sale or product brands; and recognizing livestream hosts associated with a brand, product for sale, or topic. In embodiments, the text of the user input becomes a data segment 350 that is sent to the LLM for analysis.

The infographic 300 includes determining a complexity of the audio input 330. In embodiments, the determining includes choosing an LLM 360, from one or more LLMs, wherein the choosing is based on the complexity of the audio input. There are many LLMs that have been created by artificial intelligence labs, corporate entities, private companies, and so on. Different LLMs focus on distinct aspects of language processing and production. For example, some LLMs are designed to imitate the structure and function of a human brain, so that language input and responses closely resemble human speech. Others process data segments in parallel, allowing them to predict and process text more quickly. Some work better with specific languages, including English, Mandarin, French, German, Russian, and so on. Some LLMs are designed specifically for particular industries or areas of study. In embodiments, the text data generated by the user can be analyzed and used to determine which LLM can be most effective in generating responses that meet the requirements of the user and the host system.

The infographic 300 includes processing, by the LLM 360, the data segment 350 that was sent, wherein the processing generates a final response 370 to the data segment. In embodiments, the one or more LLMs used to process the data segment are trained with voice and text interactions between users, human sales associates, help desk staff members, product experts, and AI virtual assistants. Information articles and questions covering products and services offered for sale by the website can be included in the LLM database. The information on products can be analyzed by the LLM and used to generate answers to questions and comments related to products and services offered for sale. In some embodiments, answers generated by the LLM are scored based on their correctness. A correct answer must address the question actually asked by the user and provide the appropriate information based on the information article related to the product or service involved. The final response 370 generated by the LLM 360 can be in text.

The infographic 300 includes a converting component 380. The converting component 380 can be used to convert, by a text-to-speech converter, the final response 370 to a final audio response 390. Text-to-speech (TTS) applications break down text into small units of sound called phonemes, and then use a database of recorded voices to speak each phoneme. In embodiments, the text-to-speech converter includes a synthesized voice. The synthesized voice can be based on a voiceprint from a human. The synthesized voice can include AI-generated speech. Artificial intelligence and deep learning algorithms can be used to continually update and refine the voice performances so that they are more natural and human-like. The synthesized voice is used to convert the text final response 370 to the user created by the LLM 360 into a final audio response 390.

The infographic 300 includes a producing component 392. The producing component 392 can be used to produce a final video segment, wherein the final video segment is based on the final audio response 390, wherein the producing includes animating the artificial intelligence virtual assistant, wherein the animating is based on the final audio response. In embodiments, the final audio response can be forwarded to one or more processors that have a copy of a 3D image of the synthetic human host and have access to a game engine. The game engine can be used to generate a series of animated movements, including basic actions such as sitting, standing, holding a product, presenting a video or photograph, describing an event, and so on. Specialized movements can be programmed and added to the animation as needed. Dialogue can be added so that the face of the presenter moves appropriately as the words are spoken. The image of the synthetic human host is combined with the synthesized voice and used to produce a video clip of the synthetic human performing the audio segment.

In embodiments, the synthesizing is based on phoneme mapping, wherein the phoneme mapping determines a mouth and lip position of the synthetic human. A phoneme is a discrete sound that is associated with a letter of the alphabet. Some letters have more than one associated phoneme. Phonemes can also be associated with letter combinations, such as “th,” “qu,” “ing,” and so on. In embodiments, each audio segment can be broken down into phonemes. Phonemes can be mapped to corresponding face, mouth, lip, and eye movements so that as a word is spoken by the synthetic human, the movement of the mouth, lip, face, and eyes correspond. Thus, the synthetic human is speaking the words contained in the audio segment as naturally as a real human does. Speech errors and pauses that can be added by the LLM are included in the video clip. For example, when the synthetic human pauses to “think” in the midst of a sentence, the eyes look down and to the right or up at the ceiling, along with slight tilts of the head, to simulate the process of thinking.

The infographic 300 includes a streaming component 394. The streaming component 394 can be used to stream, within the embedded interface 320, a short-form video, wherein the short-form video includes the final video segment that was produced. As video segments are generated, they can be presented immediately to the user. The embedded interface 320 displays the assembled video segment performed by the synthetic human host in a webpage window, video chat window, etc. In embodiments, as the user views the video segment and produces additional questions or comments, the capturing of user audio comments, LLM processing, TTS converting, video producing, and streaming can be repeated. The user can continue to interact with the synthetic human host, generating additional input collected by the embedded interface. The collecting of user input, creating a response, producing audio segments and related video clips, and streaming to the user continues, so that the interaction between the user and the synthetic human appears as natural as two humans interacting within a video chat.

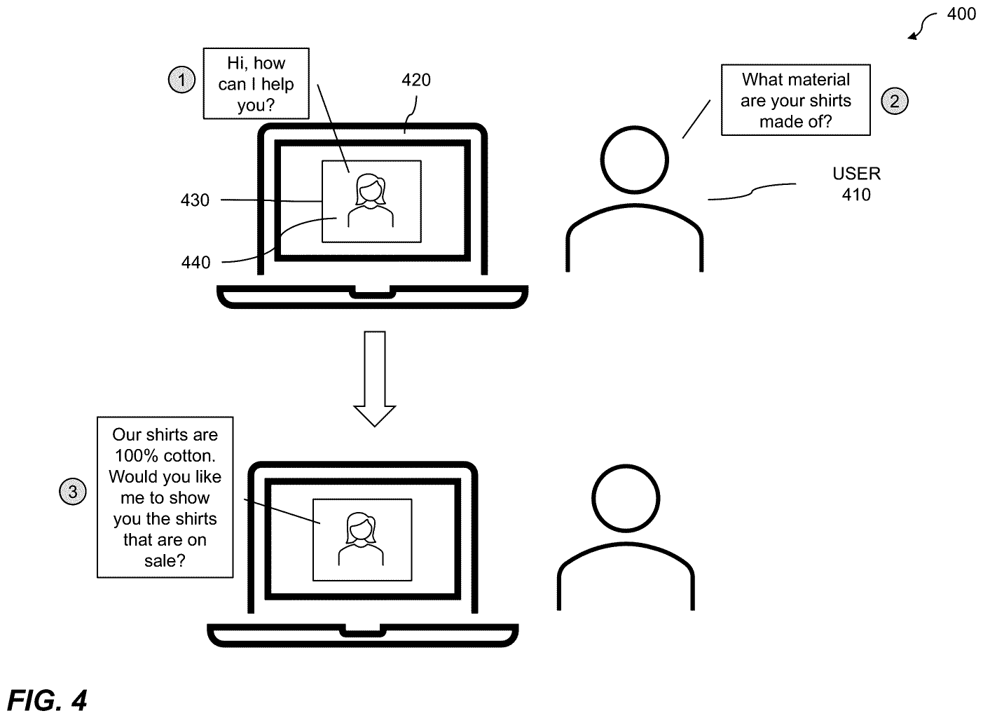

FIG. 4 is an example of an interaction with an artificial intelligence virtual assistant. The example 400 is shown in three stages. In stage 1, the example 400 includes requesting, by a user 410, an interaction, wherein the interaction is based on a product for sale within the one or more products for sale. The user accesses a website with products for sale via an embedded interface 420. The embedded interface recognizes a user request for an interaction, based on the user clicking on a help button, asking for more information in a video or audio chat, asking a question in a text box, etc. In some embodiments, information about the user is collected based on previous user interactions with the website, and demographic data available from the video chat, social media platforms, search engine information, and so on. An AI machine learning model uses the user information to select a synthetic human host 440 to interact with the user 410 through a first video segment 430 displayed in the embedded interface 420. In the example 400, the synthetic human host is shown saying, “Hi, how can I help you?”

In stage 2 of the example 400, the user 410 responds to the synthetic human host in the first video segment with a question, “What material are your shirts made of?” The example 400 includes collecting, by the embedded interface 420, the user audio input. The user input, for example, the question about shirt material, is collected by an AI machine learning model that includes a large language model (LLM) that uses natural language processing (NLP). In some embodiments, the AI machine learning model analyzes the user input and generates a response based on information articles contained in a SQuAD dataset. The SQuAD dataset is formatted to contain hundreds of questions and answers generated from the information articles on products and services offered for sale on the website. The AI machine learning model can analyze the question asked by the user and select the best response based on the product information stored in the dataset.

The example 400 includes creating, by an LLM, a response to the interaction with the user. In stage 3 of the example 400, the LLM generates a text response to the user question. The response is, “Our shirts are 100% cotton. Would you like me to show you the shirts that are on sale?” The entire text response is generated using the same voice of the synthetic human used in the first video segment (Stage 1) to create an audio stream. In embodiments, the audio stream can be edited to include pauses, speaking errors, accents, idioms, and so on to make the audio sound as natural as possible. The audio stream can be separated into segments based on the natural auditory cadence of the stream. Each segment is used to generate a video clip of the synthetic human host performing the audio segment. The audio segments are sent to one or more separate processors so that each video clip can be generated quickly and reassembled in order to be presented to the user. In embodiments, the video clips can be produced and presented to the user as additional clips are being generated. The user 410 can respond to the second video clip with additional questions, comments, and so on. For example, the user in the example 400 can say, “Yes, please do.” The AI machine learning model can then collect the response from the user and display the shirts on sale from the website. Additional videos of the synthetic human discussing additional details of the shirts can be generated, informing the user about matching clothing items such as pants, jackets, accessories, and so on.

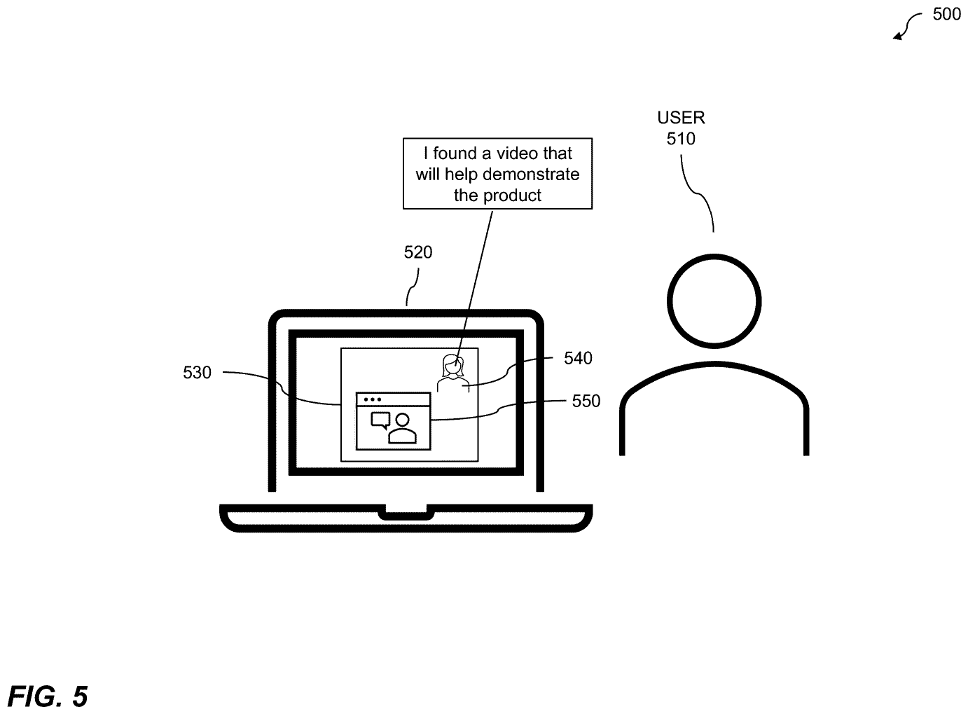

FIG. 5 is an example of an artificial intelligence virtual assistant showing a short-form video. The example 500 includes a display 520, with an embedded interface showing a first video segment 530, wherein the first video segment includes a synthetic human host 540. The first video segment 530 can include a short-form video 550 presented by the synthetic human host 540. As described above and throughout, the embedded interface includes an artificial intelligence virtual assistant, wherein the artificial intelligence virtual assistant comprises a synthetic human host 540, wherein the audio input from the user relates to one or more products for sale. In embodiments, the user input can be captured by an NLP engine and analyzed by one or more LLMs, and a final response to the user input can be generated. In embodiments, the final response can include one or more short-form videos that relate to a product or service in which the user is interested. Product demonstrations, livestreams, product expert reviews, social media influencer videos, and so on can be accessed by the LLM and included in the final response to the user. In embodiments, the LLM final response includes pointers, URLs, etc. to reference and access the short-form videos.

The example 500 includes producing a final video segment, wherein the producing includes animating the artificial intelligence virtual assistant. In embodiments, the final video segment includes the short-form video included by the LLM in the final response to the user. The LLM final response includes text to introduce and explain the short-form video that is included. In the example 500, the synthetic human host 540 is saying, “I found a video that will help demonstrate the product.” The short-form video 550 can be seen along with the synthetic human host as the video plays the product demonstration for the user. In embodiments, as the short-form video plays, user input can be captured, analyzed by the LLM, and used to generate additional dialogue for the synthetic human host. For example, the user 510 may ask about pricing or delivery times for the product as the demonstration short-form video plays. The embedded interface can capture the user questions, forward them to the NLP, convert them to text, analyze the text with the LLM, generate an answer, convert the text of the LLM response to video, and insert the video of the synthetic human host into the video segment 530 so that the host can respond to the user question as the demonstration video continues to play. In embodiments, an ecommerce environment can be included in the video segment so that the user can purchase products as the video continues to play.

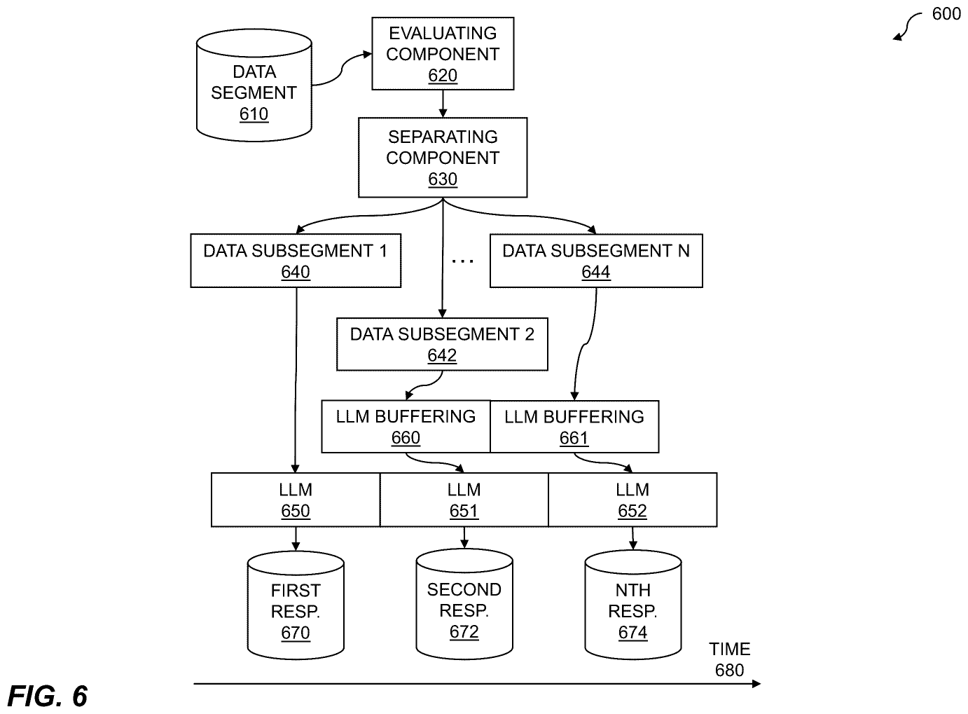

FIG. 6 is a first diagram for LLM streaming. The diagram 600 includes evaluating 620 the data segment 610, wherein the evaluating includes separating 630 the data segment into a plurality of data subsegments. The segments are shown at 640, 642, and 644. As mentioned above and throughout, the speech generated by the user can be captured by the embedded interface as an audio data segment. The audio data segment can be evaluated by a natural language processing (NLP) engine included in the large language model (LLM). The result of the evaluating component is to separate the audio data segment into a plurality of data subsegments. The separation can be based on a natural auditory cadence. The audio stream generated by the user can be broken into smaller subsegments based on the auditory cadence of the entire stream. Each sentence in the data segment can be broken down into smaller sections based on phrasing, word emphasis, the position of a word in the sentence, and so on. For example, a user looking for kitchen cabinets can ask about wood types, paint, stain, door options, and so on. These questions can be separated so that the first data subsegment contains the user question about cabinet wood types, the second subsegment contains the user question about wood stains, and so on. The order of the data subsegments can be recorded so that as they are processed by the LLM, the responses can be put back in order as they are rendered into video and displayed to the user.

The diagram 600 includes processing a first data subsegment 640 within the plurality of data subsegments, wherein the processing generates a first response 670 to the first data subsegment, wherein the first response is included in the final response. The diagram 600 also shows additional data subsegments (data subsegment 2 642 and data subsegment N 644) which can be buffered 660 (explained below) before they are processed by the LLM 650 to generate additional responses (second response 672 and Nth response 674). Any number of data segments can be processed, buffered, and converted by the LLM into a response to be included in the final response. In embodiments, the LLM processes the first data segment that was sent, wherein the processing generates a first response to the data segment. For example, the first user question about kitchen cabinet wood can generate a response from the LLM with information about maple, cherry, white oak, pine, and so on, depending on the wood types made available by the website or mobile application using the embedded interface. Information about pricing, delivery times, sizes, and so on can be included in the response, based on information available on the website. In embodiments, data subsegment 1 is sent to the LLM for processing as soon as it is captured by the NLP engine and produces a data segment. The response generated by the LLM can be a text response.

In embodiments, the first response text is converted, by a text-to-speech converter, to a final audio response. Text-to-speech (TTS) applications break down text into small units of sound called phonemes, and then use a database of recorded voices to speak each phoneme. In embodiments, the text-to-speech converter includes a synthesized voice. The synthesized voice can be based on a voiceprint from a human. The synthesized voice can include AI-generated speech. The synthesized voice is used to perform the first text response to the user created by the LLM to generate the first audio response. The first audio response is then used to produce a first video segment including the AI virtual assistant performing the first audio response. The first video segment is then streamed to the user.

The diagram 600 includes buffering 660 a second data subsegment 642 within the plurality of data subsegments. Buffering is the process of preloading and storing data in a reserved area of memory called a buffer 660. As time 680 progresses, the first video segment can be streamed to the user as the second data subsegment 642 is being processed by the LLM 650. After processing, the user interactions can require multiple responses that can be processed separately by the LLM. For example, user questions about kitchen cabinet options can be processed as separate data subsegments. The first data subsegment 640 can be processed immediately by the LLM to generate the first response 670. As the LLM 650 is generating a response to the first data subsegment up to the Nth data subsegment 644 can be stored in one or more LLM memory buffers, for example buffers 660 and 661, which can be accessed by one or more LLM instances 650, 651, and 652, for example. As each subsegment is analyzed by the LLM and a response is generated, the next subsegment can be queued up and waiting in a memory buffer to be analyzed. As soon as the first subsegment response is completed 670, the next subsegment can be processed. In some embodiments, the input subsystem of the LLM can be reading in the second data subsegment for analysis as the output subsystem of the LLM is writing out the response to the first data subsegment. In some embodiments, additional instances of the LLM can run in parallel, so that the buffer can be feeding data subsegments to multiple LLM instances at the same time. In some embodiments, different LLMs can be selected based on the complexity of the question or comment generated by the user. As each LLM response is generated, the subsegment responses can be converted into audio streams and forwarded to video processing. The result is that responses to the user requests and comments can be generated more quickly and presented in a more timely manner. Human conversations often include interruptions, returns to previous topics, requests for clarification, and so on. Capturing, buffering, and processing the user responses to the synthetic human host continuously allows the LLM to generate answers to all of the user's comments and questions quickly, so that the video presentations of the virtual assistant can keep up with the pace of the interaction and deliver all of the information the user requires.

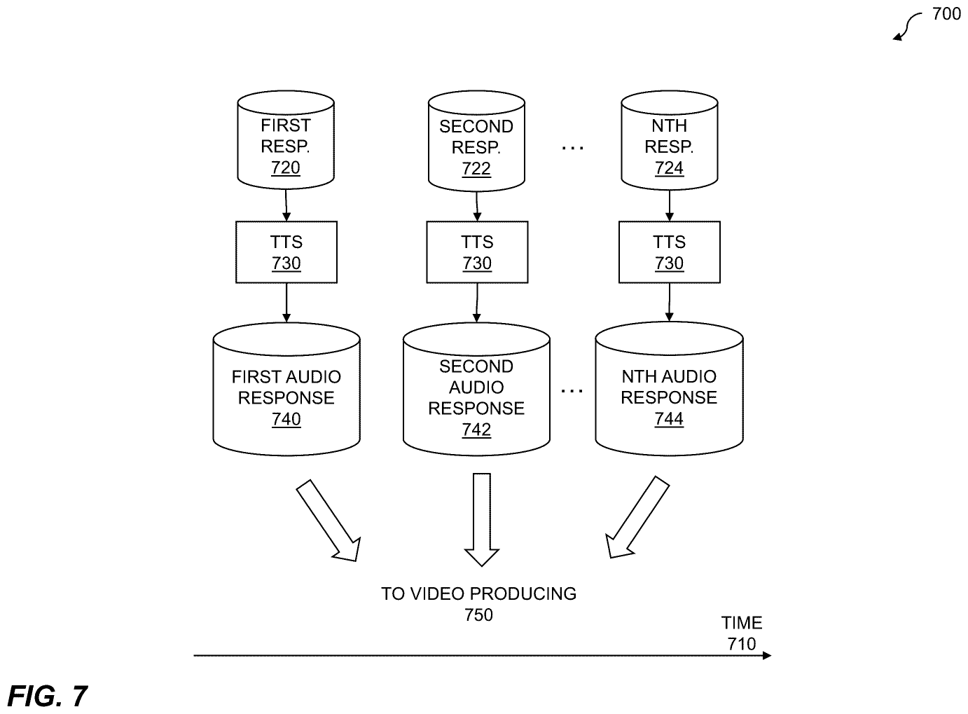

FIG. 7 is a second diagram for LLM streaming. The diagram 700 includes converting, by a text-to-speech converter 730, the first response 720 to a first audio response 740. In embodiments, the text-to-speech converter includes a synthesized voice. The synthesized voice can be based on a voiceprint from a human. The synthesized voice can include AI-generated speech. The synthesized voice is used to perform the first text response to the user created by the LLM to create the first audio response. Artificial intelligence and deep learning algorithms can be used to continually update and refine the voice performances so that they are more natural and human-like. As time progresses 710, the first audio response is completed and forwarded to video producing 750 to produce a first video segment that can be streamed to the user.

The diagram 700 includes converting, by a text-to-speech converter 730, the second response 722 to a second audio response 742 and an Nth response 724 to an Nth audio response 744, each of which can be forwarded to video producing 750 in turn. Any number of responses and audio responses can be included. In embodiments, the second through Nth responses to the user can be generated by the LLM based on multiple questions and comments made by the user in a single or multiple interactions. For example, a user can ask several questions in a single exchange, or can ask questions and make comments one at a time. The pace of the interactions between the AI virtual assistant and the user can vary, based on the speed and variety of questions asked by the user. As the user asks questions and comments, the NLP engine can capture the user input and forward the data streams to the LLM. The data streams can be buffered so that as soon as the LLM completes a response to one user comment or question, the next can be processed. Parallel LLMs that are instances of the same LLM or varied based on the complexity of the user input can be attached to the data buffers so that the production of responses from the LLM can be generated quickly and forwarded to video production. The result is a running dialogue between the synthetic human host and the user that is human-like and well-informed. The user receives the requested information in a timely manner and is able to purchase the products or services immediately using an ecommerce shopping environment included in the embedded interface.

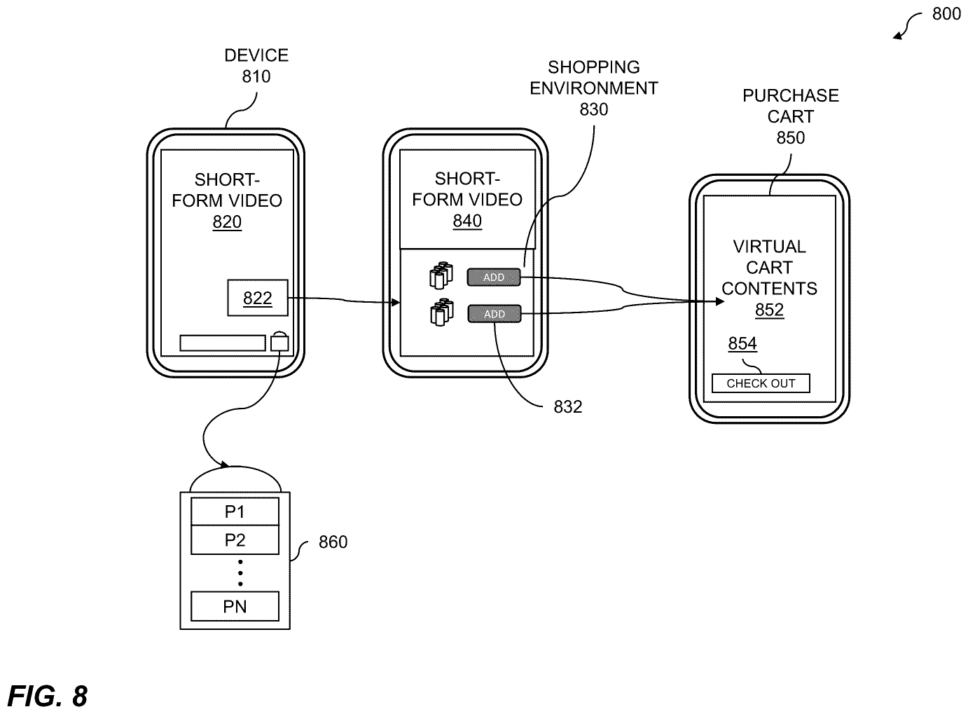

FIG. 8 is an example of an ecommerce purchase. As described above and throughout, a website user can interact with a user regarding items for sale. The interaction can include one or more short-form videos that can be accessed and viewed by one or more website users. The short-form video can highlight one or more products available for purchase. An ecommerce purchase can be enabled during a short-form video using an in-frame shopping environment. The in-frame shopping environment can allow internet connected viewers of the short-form video to buy products and services during the short-form video. The short-form video can include an on-screen product card that can be viewed on a CTV device and a mobile device. The in-frame shopping environment or window can also include a virtual purchase cart that can be used by viewers as the short-form video plays.

The example 800 includes a device 810 displaying a short-form video 820. In embodiments, the short-form video can be viewed in real time or replayed at a later time. The device 810 can be a smart TV which can be directly attached to the Internet; a television connected to the Internet via a cable box, TV stick, or game console; an Over-the-Top (OTT) device such as a mobile phone, laptop computer, tablet, pad, or desktop computer; etc. In embodiments, the accessing the short-form video on the device 810 can be accomplished using a browser or another application running on the device.

The example 800 includes generating and revealing a product card 822 on the device 810. In embodiments, the product card represents at least one product available for purchase while the short-form video plays. Embodiments can include inserting a representation of the first object into the on-screen product card. A product card is a graphical element such as an icon, thumbnail picture, thumbnail video, symbol, or other suitable element that is displayed in front of the short-form video. The product card is selectable via a user interface action such as a press, swipe, gesture, mouse click, verbal utterance, or other suitable user action. The product card can be inserted when the short-form video is visible. When the product card is invoked, an in-frame shopping environment 830 is rendered over a portion of the short-form video while the short-form video continues to play. This rendering enables an ecommerce purchase 832 by a user while preserving a continuous short-form video playback session. In other words, the user is not redirected to another site or portal that causes the short-form video playback to stop. Thus, viewers are able to initiate and complete a purchase completely inside of the short-form video playback user interface, without being directed away from the currently playing short-form video. Allowing the short-form video event to play during the purchase can enable improved audience engagement, which can lead to additional sales and revenue, one of the key benefits of disclosed embodiments. In some embodiments, the additional on-screen display that is rendered upon selection or invocation of a product card conforms to an Interactive Advertising Bureau (IAB) format. A variety of sizes are included in IAB formats, such as for a smartphone banner, mobile phone interstitial, and the like.

The example 800 can include rendering an in-frame shopping environment 830 enabling a purchase of the at least one product for sale by the viewer, wherein the ecommerce purchase is accomplished within the short-form video window 840. In embodiments, the short-form video window can include a real time short-form video or a prerecorded short-form video segment. The enabling can include revealing a virtual purchase cart 850 that supports checkout 854 of virtual cart contents 852, including specifying various payment methods, and application of coupons and/or promotional codes. In some embodiments, the payment methods can include fiat currencies such as United States dollar (USD), as well as virtual currencies, including cryptocurrencies such as Bitcoin. In some embodiments, more than one object (product) can be highlighted and enabled for ecommerce purchase. In embodiments, when multiple items 860 are purchased via product cards during the short-form video, the purchases are cached until termination of the short-form video, at which point the orders are processed as a batch. The termination of the short-form video can include the user stopping playback, the user exiting the video window, the short-form video ending, or a prerecorded short-form video ending. The batch order process can enable a more efficient use of computer resources, such as network bandwidth, by processing the orders together as a batch instead of processing each order individually.

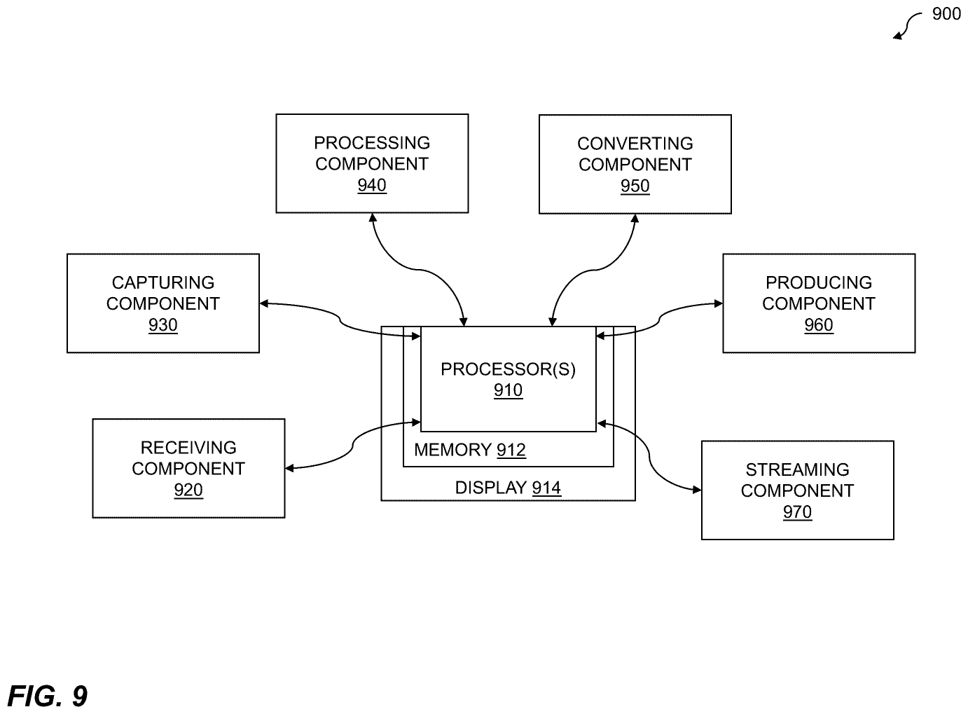

FIG. 9 is a system diagram for an artificial intelligence virtual assistant using large language model processing. The system 900 can include one or more processors 910 coupled to a memory 912 which stores instructions. The system 900 can include a display 914 coupled to the one or more processors 910 for displaying data, video streams, videos, video metadata, synthesized images, synthesized image sequences, synthesized videos, search results, sorted search results, search parameters, metadata, webpages, intermediate steps, instructions, and so on. In embodiments, one or more processors 910 are coupled to the memory 912, wherein the one or more processors, when executing the instructions which are stored, are configured to: receive audio input from a user, wherein the receiving occurs within an embedded interface, wherein the embedded interface includes an artificial intelligence virtual assistant, wherein the artificial intelligence virtual assistant comprises a synthetic human host, wherein the audio input from the user relates to one or more products for sale, and wherein the audio input comprises an interaction; capture, by a natural language processing (NLP) engine, the audio input, wherein the capturing produces a data segment, and wherein the data segment is sent to a large language model (LLM); process, by the LLM, the data segment that was sent, wherein the processing generates a final response to the data segment; convert, by a text-to-speech converter, the final response to a final audio response; produce a final video segment, wherein the final video segment is based on the final audio response, wherein the producing includes animating the artificial intelligence virtual assistant, wherein the animating is based on the final audio response; and stream, within the embedded interface, a short-form video, wherein the short-form video includes the final video segment that was produced.

The system 900 includes a receiving component 920. The receiving component 920 includes functions and instructions for receiving audio input from a user, wherein the receiving occurs within an embedded interface, wherein the embedded interface includes an artificial intelligence virtual assistant, wherein the artificial intelligence virtual assistant comprises a synthetic human host, wherein the audio input from the user relates to one or more products for sale, and wherein the audio input comprises an interaction. In embodiments, the audio input is included in a video chat. The user can speak to a video chat window; into a mobile phone, pad, or tablet; and so on. The user input comprises text. The user can respond to the synthetic human by typing a question or comment into a chat text box. The text box can be generated by a website or the embedded interface window. In embodiments, the embedded interface can comprise a website. The website can be an ecommerce site for a single vendor or brand, a group of businesses, a social media platform, and so on. The website can be displayed on a portable device. The portable device can be an Over-the-Top (OTT) device such as a mobile phone, laptop computer, tablet, or pad. The accessing of the website can be accomplished using a browser running on the device. In embodiments, the embedded interface comprises an app running on a mobile device. The app can use HTTP, TCP/IP, or DNS to communicate with the Internet, web servers, cloud-based platforms, and so on.

In embodiments, the artificial intelligence (AI) virtual assistant comprised of a synthetic human host can be based on the user information collected by the embedded interface. In some embodiments, a game engine can be used to generate a series of animated movements, including basic actions such as sitting, standing, holding a product, presenting a video or photograph, describing an event, and so on. Specialized movements can be programmed and added to the animation as needed. Dialogue can be added so that the face of the presenter moves appropriately as the words are spoken. The result is a performance by the synthetic human, combining animation generated by a game engine and the 3D model of the individual, including the voice of the individual.

The system 900 includes a capturing component 930. The capturing component 930 includes functions and instructions for capturing, by a natural language processing (NLP) engine, the audio input, wherein the capturing produces a data segment, and wherein the data segment is sent to a large language model (LLM). In embodiments, the audio input generated by the user is converted into text, including any user errors, incorrect words, grammar inconsistencies, and so on. The conversion can be done using an online conversion application, AI transcription service, automatic speech recognition (ASR) application, and so on. In some embodiments, the natural language processing (NLP) engine converts the audio input to text. The large language model (LLM) uses NLP to understand the text and the context of voice and text communication during the interaction. The LLM database can include audio and text interactions between users and the synthetic human host. NLP can be used to detect one or more topics discussed by the user and synthetic human. In embodiments, the text of the user input becomes a segment of data that is sent to the LLM for analysis.

The system 900 includes a processing component 940. The processing component 940 includes functions and instructions for processing, by the LLM, the data segment that was sent, wherein the processing generates a final response to the data segment. In embodiments, the one or more LLMs used to process the data segment are trained with voice and text interactions between users, human sales associates, help desk staff members, product experts, and AI virtual assistants. Information articles and questions covering products and services offered for sale by the website can be included in the LLM database. The information on products can be analyzed by the LLM and used to generate answers to questions and comments related to products and services offered for sale. The response generated by the LLM can be in text.

The system 900 includes a converting component 950. The converting component 950 includes functions and instructions for converting, by a text-to-speech converter, the final response to a final audio response. In embodiments, text-to-speech (TTS) applications break down text into small units of sound called phonemes, and then use a database of recorded voices to speak each phoneme. In embodiments, the text-to-speech converter includes a synthesized voice. The synthesized voice can be based on a voiceprint from a human. The synthesized voice can include AI-generated speech. The synthesized voice is used to perform the text response to the user created by the LLM.

The system 900 includes a producing component 960. The producing component 960 includes functions and instructions for producing a final video segment, wherein the final video segment is based on the final audio response, wherein the producing includes animating the artificial intelligence virtual assistant, wherein the animating is based on the final audio response. In embodiments, the final audio response can be forwarded to one or more processors that have a copy of a 3D image of the synthetic human host and access to a game engine. The image of the synthetic human host is combined with the synthesized voice and used to generate a video clip of the synthetic human performing the audio segment. In embodiments, the synthesizing is based on phoneme mapping, wherein the phoneme mapping determines a mouth and lip position of the synthetic human. Each audio segment can be broken down into phonemes. Phonemes can be mapped to corresponding face, mouth, lip, and eye movements so that as a word is spoken by the synthetic human, the movements of the mouth, lip, face, and eyes correspond. Thus, the synthetic human is speaking the words contained in the audio segment as naturally as a real human does. Speech errors and pauses added by the LLM are included in the video clip. For example, when the synthetic human pauses to “think” in the midst of a sentence, the eyes look down and to the right or up at the ceiling, along with slight tilts of the head, to simulate the process of thinking.

The system 900 includes a streaming component 970. The streaming component 970 includes functions and instructions for streaming, within the embedded interface, a short-form video, wherein the short-form video includes the final video segment that was produced. As video segments are generated, they can be streamed immediately to the user. The embedded interface displays the assembled video segment performed by the synthetic human host in a webpage window, video chat window, etc. In embodiments, as the user views the video segment and produces additional questions or comments, the capturing of user comments, LLM processing, TTS converting, video producing, and streaming can be repeated. The user can continue to interact with the synthetic human host, generating additional input collected by the embedded interface. The collection of user input, creating a response, producing audio segments and related video clips, and streaming to the user continues, so that the interaction between the user and the synthetic human appears as natural as two humans interacting within a video chat.

The system 900 can include a computer program product embodied in a non-transitory computer readable medium for searching, the computer program product comprising code which causes one or more processors to perform operations of: receiving audio input from a user, wherein the receiving occurs within an embedded interface, wherein the embedded interface includes an artificial intelligence virtual assistant, wherein the artificial intelligence virtual assistant comprises a synthetic human host, wherein the audio input from the user relates to one or more products for sale, and wherein the audio input comprises an interaction; capturing, by a natural language processing (NLP) engine, the audio input, wherein the capturing produces a data segment, and wherein the data segment is sent to a large language model (LLM); processing, by the LLM, the data segment that was sent, wherein the processing generates a final response to the data segment; convert, by a text-to-speech converter, the final response to a final audio response; producing a final video segment, wherein the final video segment is based on the final audio response, wherein the producing includes animating the artificial intelligence virtual assistant, wherein the animating is based on the final audio response; and streaming, within the embedded interface, a short-form video, wherein the short-form video includes the final video segment that was produced.

The system 900 can include a computer system for searching comprising: a memory which stores instructions; one or more processors coupled to the memory, wherein the one or more processors, when executing the instructions which are stored, are configured to: receive audio input from a user, wherein the receiving occurs within an embedded interface, wherein the embedded interface includes an artificial intelligence virtual assistant, wherein the artificial intelligence virtual assistant comprises a synthetic human host, wherein the audio input from the user relates to one or more products for sale, and wherein the audio input comprises an interaction; capture, by a natural language processing (NLP) engine, the audio input, wherein the capturing produces a data segment, and wherein the data segment is sent to a large language model (LLM); process, by the LLM, the data segment that was sent, wherein the processing generates a final response to the data segment; convert, by a text-to-speech converter, the final response to a final audio response; produce a final video segment, wherein the final video segment is based on the final audio response, wherein the producing includes animating the artificial intelligence virtual assistant, wherein the animating is based on the final audio response; and stream, within the embedded interface, a short-form video, wherein the short-form video includes the final video segment that was produced.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagram and flow diagram illustrations depict methods, apparatus, systems, and computer program products. The elements and combinations of elements in the block diagrams and flow diagrams show functions, steps, or groups of steps of the methods, apparatus, systems, computer program products and/or computer-implemented methods. Any and all such functions generally referred to herein as a “circuit,” “module,” or “system” may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A computer-implemented method for video streaming comprising:
receiving audio input from a user, wherein the receiving occurs within an embedded interface, wherein the embedded interface includes an artificial intelligence virtual assistant, wherein the artificial intelligence virtual assistant comprises a synthetic human host, wherein the audio input from the user relates to one or more products for sale, and wherein the audio input comprises an interaction;
capturing, by a natural language processing (NLP) engine, the audio input, wherein the capturing produces a data segment, and wherein the data segment is sent to a large language model (LLM);
processing, by the LLM, the data segment that was sent, wherein the processing generates a final response to the data segment;
converting, by a text-to-speech converter, the final response to a final audio response;
producing a final video segment, wherein the final video segment is based on the final audio response, wherein the producing includes animating the artificial intelligence virtual assistant, wherein the animating is based on the final audio response; and
streaming, within the embedded interface, a short-form video, wherein the short-form video includes the final video segment that was produced.

2. The method of claim 1 further comprising evaluating the data segment, wherein the evaluating includes separating the data segment into a plurality of data subsegments.

3. The method of claim 2 wherein the processing includes a first data subsegment within the plurality of data subsegments, wherein the processing generates a first response to the first data subsegment, wherein the first response is included in the final response.

4. The method of claim 3 wherein the converting includes the first response.

5. The method of claim 2 further comprising buffering a second data subsegment within the plurality of data subsegments.

6. The method of claim 5 wherein the processing includes the second data subsegment, wherein the processing generates a second response to the second data subsegment, wherein the second response is included in the final response.

7. The method of claim 6 wherein the converting includes the second response.

8. The method of claim 1 wherein the text-to-speech converter includes a synthesized voice.

9. The method of claim 8 wherein the synthesized voice is based on a voiceprint from a human.

10. The method of claim 8 wherein the synthesized voice includes AI-generated speech.

11. The method of claim 1 wherein the converting includes adding, to the final audio response, one or more simulations of human speech errors.

12. The method of claim 11 wherein the final audio response includes pauses to simulate human cognitive processing rates.

13. The method of claim 1 further comprising determining a complexity of the audio input.

14. The method of claim 13 further comprising choosing an LLM, from one or more LLMs, wherein the choosing is based on the complexity of the audio input.

15. The method of claim 1 wherein the streaming includes enabling an ecommerce purchase of the one or more products for sale.

16. The method of claim 15 wherein the ecommerce purchase includes a representation of the one or more products for sale in an on-screen product card.

17. The method of claim 15 wherein the enabling the ecommerce purchase includes a virtual purchase cart.

18. The method of claim 17 wherein the virtual purchase cart covers a portion of the short-form video that was streamed.

19. A computer program product embodied in a non-transitory computer readable medium for video streaming, the computer program product comprising code which causes one or more processors to perform operations of:
receiving audio input from a user, wherein the receiving occurs within an embedded interface, wherein the embedded interface includes an artificial intelligence virtual assistant, wherein the artificial intelligence virtual assistant comprises a synthetic human host, wherein the audio input from the user relates to one or more products for sale, and wherein the audio input comprises an interaction;
capturing, by a natural language processing (NLP) engine, the audio input, wherein the capturing produces a data segment, and wherein the data segment is sent to a large language model (LLM);
processing, by the LLM, the data segment that was sent, wherein the processing generates a final response to the data segment;
converting, by a text-to-speech converter, the final response to a final audio response;
producing a final video segment, wherein the final video segment is based on the final audio response, wherein the producing includes animating the artificial intelligence virtual assistant, wherein the animating is based on the final audio response; and
streaming, within the embedded interface, a short-form video, wherein the short-form video includes the final video segment that was produced.

20. A computer system for video streaming comprising:
a memory which stores instructions;
one or more processors coupled to the memory, wherein the one or more processors, when executing the instructions which are stored, are configured to:
receive audio input from a user, wherein the receiving occurs within an embedded interface, wherein the embedded interface includes an artificial intelligence virtual assistant, wherein the artificial intelligence virtual assistant comprises a synthetic human host, wherein the audio input from the user relates to one or more products for sale, and wherein the audio input comprises an interaction;
capture, by a natural language processing (NLP) engine, the audio input, wherein the capturing produces a data segment, and wherein the data segment is sent to a large language model (LLM);
process, by the LLM, the data segment that was sent, wherein the processing generates a final response to the data segment;
convert, by a text-to-speech converter, the final response to a final audio response;
produce a final video segment, wherein the final video segment is based on the final audio response, wherein the producing includes animating the artificial intelligence virtual assistant, wherein the animating is based on the final audio response; and
stream, within the embedded interface, a short-form video, wherein the short-form video includes the final video segment that was produced.
